(19) United States
(12) Patent Application Publication
(10) Pub. No.: US 2008/0253335 A1
(43) Pub. Date: Oct. 16, 2008

(54) METHOD OF VIDEO DISTRIBUTION IN WIRELESS NETWORKS

(76) Inventors: Peter Bosch, New Providence, NJ (US); Sudeep Kumar Palat, Swindon (GB)

Correspondence Address: MARK W. SINCELL;Williams, Morgan & Amerson, P.C., Suite 1100, 10333 Richmond, Houston, TX, 77042, US

(21) Appl. No.: 11/735,621

(22) Filed: Apr. 16, 2007

(51) Int. Cl. H04B 7/216

(52) U.S. Cl. 370/335

(57) ABSTRACT

The present invention provides a method of allocating resources for transmission a broadcast data in a distributed network. One embodiment of the method may include selecting a first base station router from a plurality of base station routers. The first base station router is selected to allocate resources of the plurality of base station routers for providing the broadcast data. The method may also include providing the broadcast data to the plurality of base station routers. The broadcast data is configured for broadcast by each of the plurality of base station routers according to a resource allocation determined by the first base station router.

### BACKGROUND OF THE INVENTION

1. Field of the Invention

This invention relates generally to communication systems, and, more particularly, to wireless communication systems.

2. Description of the Related Art

Wireless communication systems can be used to broadcast audio and/or video streams to numerous mobile units. For example, the users of the mobile units may subscribe to a broadcast service, such as a pay-per-view service, that streams audio and/or video to the mobile units at selected times. In conventional hierarchical wireless communications, a broadcast server transmits broadcast data (including the data used to generate the audio and/or video) to a central element such as such as a Radio Network Controller (RNC). The RNC may then transmit paging messages to the subscribed mobile units via one or more base stations. The mobile units may establish a wireless link to one or more of the base stations in response to receiving the page from the wireless communication system. A radio resource management function within the RNC receives the broadcast data and coordinates the radio and time resources used by the set of base stations to transmit the broadcast. The radio resource management function can perform fine grain control to allocate and release resources for broadcast transmission over a set of base stations.

Coordinating the transmissions of data from a set of base stations (which may be referred to hereinafter as the soft handover group) may permit the mobile units to merge incoming signals to boost the signal-to-noise ratio at the mobile unit. In the case of transmissions using the Code Division Multiple Access (CDMA) protocols, the mobile unit receives energy through its antenna and combines the information received from multiple base stations in an analog form before attempting to decode the information. In the case of transmissions using Orthogonal Frequency Division Multiplexing (OFDM) systems, a more natural combining happens by enabling the tones that are transmitted over the air to constructively (or destructively) interfere with each other, thereby potentially boosting the signal-to-noise ratio of the signal at the mobile unit. However, in order to realize the hoped-for increase in the signal-to-noise ratio, all base stations participating in the soft handover group need to be properly synchronized. For example, CDMA signals from different base stations must be synchronized sufficiently so that the mobile is able to combine the signals from the multiple base stations in the analog domain. For another example, OFDM signals transmitted by different base stations must be time synchronized so that symbols can interfere constructively (or destructively) at the mobile unit.

One alternative to the conventional hierarchical network architecture is a distributed architecture including a network of access points, such as base station routers, that implement distributed communication network functionality. For example, each base station router may combine RNC and/or PDSN functions in a single entity that manages radio links between one or more mobile units and an outside network, such as the Internet. Base station routers wholly encapsulate the cellular access technology and may proxy functionality that utilizes core network element support to equivalent IP functions. For example, IP anchoring in a UMTS base station router may be offered through a Mobile IP Home Agent (HA) and the GGSN anchoring functions that the base station router proxies by through equivalent Mobile IP signaling. Compared to hierarchical networks, distributed architectures have the potential to reduce the cost and/or complexity of deploying the network, as well as the cost and/or complexity of adding additional wireless access points, e.g. base station routers, to expand the coverage of an existing network. Distributed networks may also reduce (relative to hierarchical networks) the delays experienced by users because packet queuing delays at the RNC and PDSN of hierarchical networks may be reduced or removed.

Distributed architectures do not, however, include a central element that is capable of hosting the radio resource management functions that are needed to support broadcast services. Broadcasts in distributed architectures are therefore difficult to synchronize in a manner that permits soft combining of transmissions from a group of base station routers. Consequently, distributed architectures may not be able to take advantage of the techniques that are commonly used to boost the signal-to-noise ratios of broadcast transmissions in hierarchical systems.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for allocating resources for transmission of broadcast data in a distributed network. One embodiment of the method may include selecting a first base station router from a plurality of base station routers. The first base station router is selected to allocate resources of the plurality of base station routers for providing the broadcast data. The method may also include providing the broadcast data to the plurality of base station routers. The broadcast data is configured for broadcast by each of the plurality of base station routers according to a resource allocation determined by the first base station router.

In another embodiment of the present invention, a method is provided for allocating resources for transmission a broadcast data in a distributed network. One embodiment of the method may include receiving, at a first base station router, information indicating that the first base station router is selected to allocate resources of at least one second base station router for providing the broadcast data. The method may also include receiving, at the first base station router, the broadcast data. The broadcast data is configured for broadcast by the first base station router and the second base station router(s) according to a resource allocation determined by the first base station router.

In yet another embodiment of the present invention, a method is provided for allocating resources for transmission of broadcast data in a distributed network. One embodiment of the method may include receiving, at a first base station router, information indicating that a second base station router has been selected to allocate resources of the first base station router for providing the broadcast data. The method may also include receiving, at the first base station router, the broadcast data. The broadcast data is configured for broadcast by the first base station router according to a resource allocation determined by the second base station router.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a first exemplary embodiment of a distributed wireless communication system, in accordance with the present invention;

FIG. 2 conceptually illustrates a second exemplary embodiment of a distributed wireless communication system, in accordance with the present invention;

FIG. 3 conceptually illustrates a portion of a data stream transmitted from a broadcast server to a multicast group and a portion of a data stream transmitted by base station routers in the multicast group, in accordance with the present invention; and

FIG. 4 conceptually illustrates one exemplary embodiment of a method of allocating resources for providing broadcast services in a distributed communication system, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i. e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

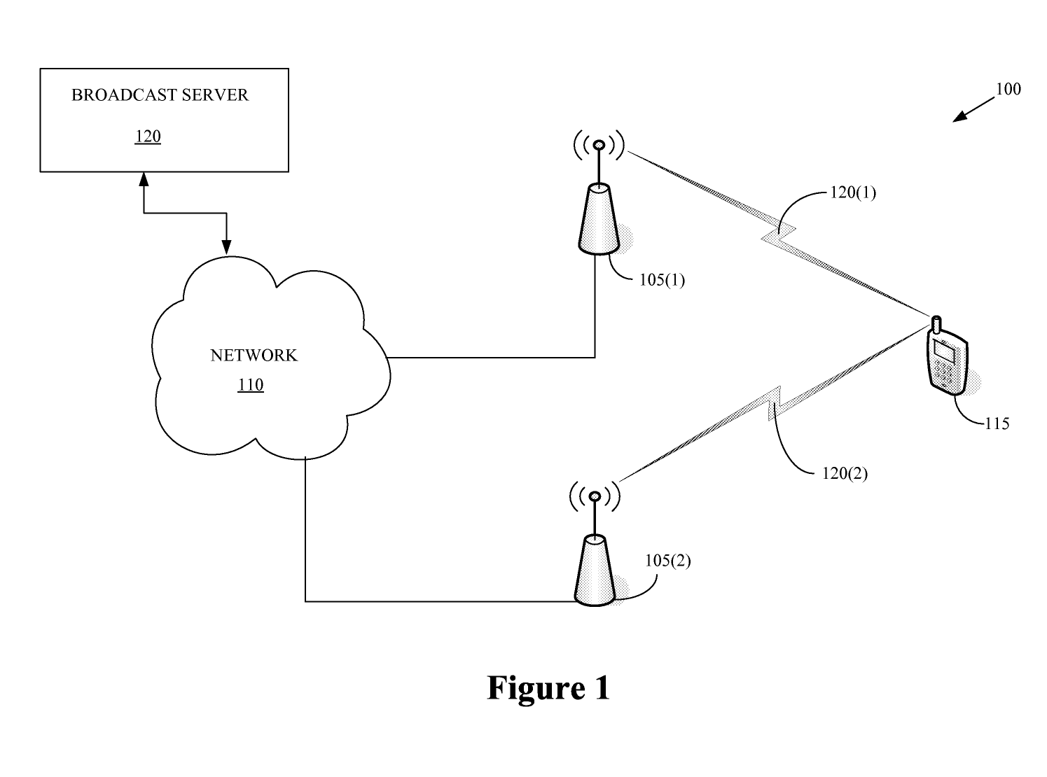

FIG. 1 conceptually illustrates a first exemplary embodiment of a distributed wireless communication system 100. In the illustrated embodiment, access points for the distributed wireless communication system 100 include a distributed network of base station routers 105(1-2). Hereinafter, in the interest of clarity, the base station routers 105(1-2) will be referred to collectively by the index 105 unless the description is referring to a specific base station router 105, such as the base station router 105(1). Although the present invention will be described in the context of the distributed wireless communication system 100 comprising a plurality of base station routers 105, persons of ordinary skill in the art should appreciate that the present invention is not limited to distributed wireless communication systems 100 in which the access points are base station routers 105. In alternative embodiments, the distributed wireless communication system 100 may include any number and/or type of access point that is configured to include distributed communication network functionality, such as described herein.

The base station routers 105 are communicatively coupled to a network 110. The base station routers 105 may be coupled to the network 110 by any combination of wired and/or wireless connections, which may operate according to any combination of wired and/or wireless communication standards and/or protocols. For example, the base station routers 105 and the network 110 may operate according to Universal Mobile Telecommunication System (UMTS) standards and/or protocols, such as defined by the Third Generation Partnership Project (3GPP). Each of the base station routers 105 may be capable of initiating, establishing, maintaining, transmitting, receiving, terminating, or performing any other action related to a call session with one or more mobile units, such as the mobile unit 115 shown in FIG. 1. For example, each base station router 105 may combine functions from the Radio Network Controller (RNC) and Serving GPRS Support Node (SGSN) and Gateway GPRS Support Node (GGSN) in a single entity. The base station routers 105 may also be configured to communicate with other base station routers 105, other devices, other networks, and the like in a manner known to persons of ordinary skill in the art. Techniques for implementing and/or operating base station routers 105 are known in the art and in interest of clarity only those aspects of implementing and/or operating base station routers 105 that are relevant to the present invention will be discussed in detail herein.

The mobile unit 115 may register with the base station router 105(1) to establish a call session. Each base station router 105 can create, assign, transmit, receive, and/or store information related to the call sessions established between the base station routers 105 and the mobile unit 115. This information will be collectively referred to hereinafter as state information, in accordance with common usage in the art. For example, the state information may include security information associated with the call session, subscription information for broadcast and/or multicast services such as MBMS, home agent keys, information that may be used to connect to signal gateways in the wireless communication system 100, other link layer information, information related to an air interface protocol, one or more sequence numbers, a re-sequencing buffer, and the like. The state information may also include information related to a Packet Data Convergence Layer (PDCP), such as header compression information, payload compression information, and related parameters. State information related to other protocol layers may also be created, transmitted, received, and/or stored by the base station routers 105. This state information may be negotiated and/or generated during the registration procedure to establish the call session or during the call session itself.

A user of the mobile unit 115 may register for (or subscribe to) a broadcast or multicast service provided by a broadcast server 120, such as a MBMS service. Thus, the broadcast server 120 may broadcast data associated with a broadcast or multicast service to the mobile unit 115 over one or more air interfaces 125. In the illustrated embodiment, the base station routers 105 are part of a multicast group, such as an Internet Protocol multicast group, and are therefore all able to transmit information associated with the broadcast service to the mobile unit 115 over the air interfaces 125. The ability of the mobile unit 115 to receive and/or decode information provided by the broadcast server 120 may be significantly improved by synchronizing or coordinating transmissions from the base station routers 105 in the multicast group so that the mobile unit 115 may combine information and/or signals provided by the base station routers 105.

In one embodiment, transmissions of the base station routers 105 may be coordinated by transmitting all of the broadcast data from the broadcast server 120 to a single base station router, e.g., the base station router 105(1), which is then responsible for scheduling data transmissions by all of the base station routers 105 in the soft handover group, as well as providing the broadcast data to the soft handover group. However, this approach may significantly increase overhead and backhaul traffic, at least in part because the broadcast data is first transmitted over the backhaul link to the coordinating base station router 105(1) and then the broadcast data is transmitted back over the backhaul link to the other base station routers 105 in the soft handover group. The base station router 105(1) that hosts the radio resource management function may therefore be overwhelmed with data for the broadcast data. Moreover, in this embodiment, the links connecting the base station routers 105 should be provisioned in such a way that these links can sustain all broadcast data that is potentially transmitted over a set of base station routers 105. These problems may be exacerbated by the fact that the backhaul link in a flat (distributed) architecture is typically the slowest (and most expensive) link in the wireless communication network 100.

These drawbacks may be reduced or eliminated by selecting a single base station router, e.g., the base station router 105(1), to function as a resource manager for all of the base station routers 105 in the soft handover group. However, in contrast to the previous embodiment, the broadcast data is transmitted from the broadcast server 120 to each of the base station routers 105 in the soft handover group. For example, the broadcast server 120 may transmit the broadcast data to the base station routers 105 via the network 110 according to the IP multicast group standards and/or protocols. In this way, the broadcast data can bypass the resource manager 105(1) when it is provided to the base station routers 105, thereby removing the need to transmit the broadcast data over the backhaul link twice. The resource manager, e.g., the base station router 105(1), may then allocate the resources to be used by the base station routers 105 to transmit the broadcast data to the mobile unit 115. Information indicating the resource allocation determined by the resource manager may be transmitted to all of the base station routers 105, which may use this information to coordinate and/or synchronize transmissions over the air interfaces 120 so that the mobile unit 115 may combine the information and/or signals received over the air interfaces 120.

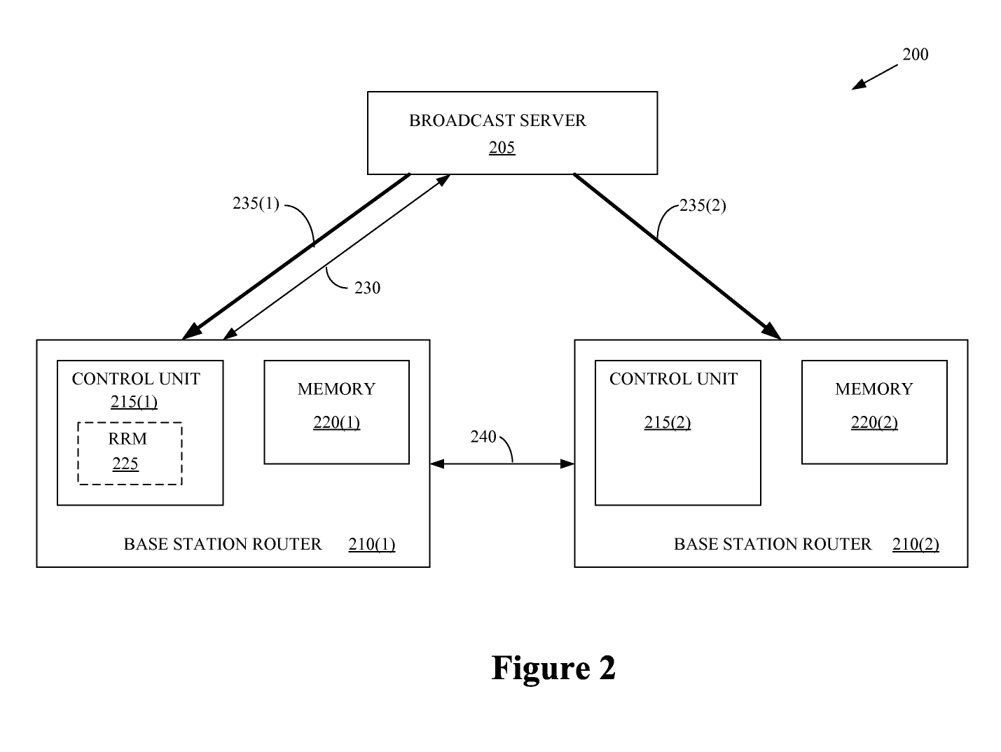

FIG. 2 conceptually illustrates a second exemplary embodiment of a distributed wireless communication system 200. In the illustrated embodiment, a broadcast server 205 is communicatively coupled to a plurality of base station routers 210 that are part of a multicast group. Although two base station routers 210 are depicted in FIG. 2, persons of ordinary skill in the art having benefit of the present disclosure should appreciate that the present invention is not limited to wireless communication systems 200 that include two base station routers 210. In alternative embodiments, the distributed wireless communication system 200 may include any number of base station routers 210 and/or other access points that may be configured to provide access to a distributed communication network. Furthermore, the broadcast server 205 may be communicatively coupled to the base station routers 210 using any combination of wired and/or wireless communication networks. Each base station router 210 includes a control unit 215 and a memory element 220. For example, the control unit 215 may be implemented as a central processing unit or other processor and the memory element 220 may be implemented as one or more random access memory devices.

One of the base station routers 210 may host a radio resource management function 225 associated with one or more services provided by the broadcast server 205. In the illustrated embodiment, the network 200 selects the base station router 210(1) to host the radio resource management (RRM) function 225. Although no radio resource management function is depicted in the base station router 210(2), this is not intended to imply that the base station router 210(2) is incapable of hosting a radio resource management function. Persons of ordinary skill in the art having benefit of the present disclosure should appreciate that any of the base station routers 210 may be selected to host (and be capable of hosting) the radio resource management function 225 for one or more of the services provided by the broadcast server 205. Once the broadcast server 205 has selected the base station router 210(1) to host the radio resource management function 225, the broadcast server 205 and the radio resource management function 225 may negotiate information related to allocating resources for providing one or more services, as indicated by the arrow 230. For example, the identities and wireless transmission scheduling parameters of the base station routers 210 in the soft handover group for the service may be negotiated, e.g., using a two-phase and/or a three-phase commit protocol. These commit protocols are known in the art and in the interest of clarity will not be discussed in detail herein.

Selection of the resource manager 210(1) may be based on any criteria and may change over time, e.g., different base station routers 210 may be selected to act as the resource manager at different times. In one embodiment, the resource manager 210(1) may be selected based on network information such as channel conditions, network topology, available capacity in portions of the network, and the like. The resource manager 210(1) may also be selected based upon geographic information. In one embodiment, broadcast services may be regionally mapped and/or mapped to the expected user base. For example, a broadcast service such as a Wall Street news broadcast that is applicable to users in Manhattan, N.Y. may have little relevance to users in rural areas such as Manhattan, Kans. Similarly, weather services may be tailored to particular locations. More complicated mappings can also be envisioned. In one embodiment, a base station router 210 may be selected as the keeper of the radio resource management function 225 for a particular broadcast service and the selected based station router 210 may negotiate with other base station routers 210 within its region for reservation of resources that may be used to provide a particular service. When two radio resource management areas overlap, resolution may be required to resolve conflicts in resource allocation. In these cases, two-phase or three-phase commit protocol may be used to resolve atomic reservations. To resolve conflicts quickly, the protocols may be extended with a mechanism that allows base station routers 210 to suggest alternate allocations for the broadcast service.

The broadcast server 205 may also distribute content associated with the provided services to each of the base station routers 210, as indicated by the arrows 235. In one embodiment, the broadcast server 205 may transmit broadcast data to the base station routers 210 in the multicast group according to an Internet Protocol multicast standard and/or protocol. The broadcast data bypasses the radio resource management function 225 so that the base station routers 210 may receive the broadcast data without involvement of the radio resource management function 225. The broadcast data includes information indicating the time at which the broadcast data is to be displayed to the user. In various alternative embodiments, the display time may indicate an absolute time that a portion of the broadcast data is to be displayed and/or a relative time that a portion of the broadcast data is to be displayed. For example, the time indication may indicate that a frame of the broadcast data is to be displayed to the user at a specific time, e.g., in Greenwich Mean Time. For another example, the time indication may indicate that the frame of the broadcast data is to be displayed to the user one second after the previous frame of the broadcast data.

The radio resource management function 225 allocates resources to be used by the base station routers 210 for transmission of the broadcast data over the air interface. In one embodiment, allocating the resources includes scheduling transmission of portions of the broadcast data. For example, the radio resource management function 225 may negotiate a mapping (or other functional relationship) between the timing indication included in the broadcast data and the access-technology specific timing used by the base station routers 210 to transmit information over the air interface, as indicated by the arrow 240. Exemplary access-technology specific timing indicators include the system frame number (SFN) defined by the Universal Mobile Telecommunication System (UMTS) standards and/or protocols and/or an absolute timestamp that indicates the time at which the base station routers 210 are to transmit a portion of the broadcast data. In one embodiment, the radio resource management function 225 negotiates (at 240) the mapping by executing a protocol, e.g. a two-phase or three-phase commit protocol, with the base station routers 210 that allows the radio resource management function 225 to determine parameters such as the maximum delay and/or the jitter for receiving data on the multicast group. The radio resource management function 225 may then allocate resources based upon the negotiated parameters.

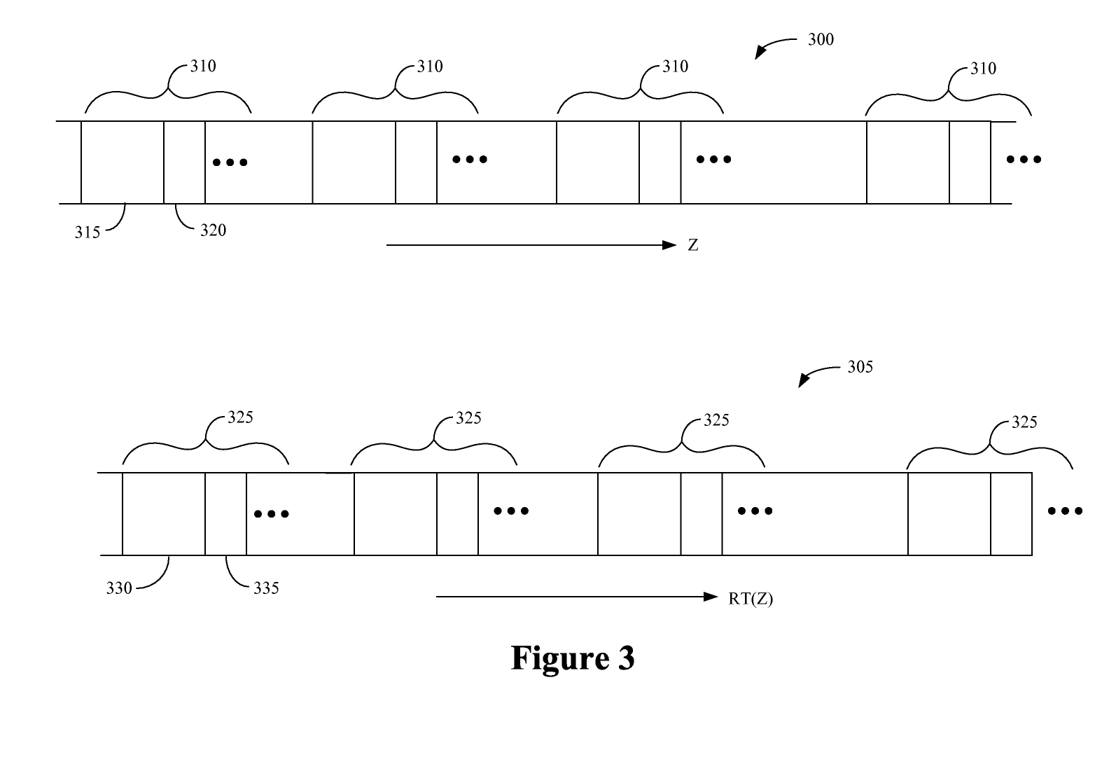

FIG. 3 conceptually illustrates a portion of a data stream 300 transmitted from a broadcast server to a multicast group and a portion of a data stream 305 transmitted by base station routers in the multicast group. In the illustrated embodiment, each frame 310 in the data stream 300 includes a payload 315 and a timestamp 320. For example, the payload 315 may include portions of the broadcast data and the timestamp 320 may include information indicating absolute and/or relative timing (Z) for providing the broadcast data in the payload 315 to a user. In alternative embodiments, the frame 310 may also include other information, such as one or more headers, in addition to the payload 315 and the timestamp 320.

In the illustrated embodiment, each frame 325 in the data stream 305 includes a payload 330 and a timestamp 335. For example, the payload 330 may include portions of the broadcast data from an associated payload 315 from a frame 310 and the timestamp 335 may include information indicating absolute and/or relative timing, RT(Z), for providing the broadcast data in the payload 330 to a user. The timing indication RT(Z) is determined by a mapping of the timing Z indicated by the timestamp 320 to the access-technology specific timing implemented in the base station routers. For example, the resource management function in one of the base station routers may determine the function RTO that is used to map the timing Z to RT(Z) based upon negotiated maximum delay is and/or jitter. In one embodiment, the mapping function RTO may also provide mapping information that indicates how each base station router should encode the data (e.g. the modulation and coding parameters). The resource management function may then distribute the function RTO to the base station routers, which may use the provided function to calculate RT(Z) using the provided time stamp Z. In alternative embodiments, the frame 325 may also include other information, such as one or more headers, in addition to the payload 330 and the timestamp 335.

Referring back to FIG. 2, the radio resource management function 225 may also negotiate (as indicated by arrow 240) the channels and/or tones that will be used by the base station routers 210 to transmit the broadcast data. In one embodiment, the radio resource management function 225 may use a reservation protocol such as a two-phase or three-phase commit protocol to allocate resources on each of the base station routers. Thus, the radio resource management function 225 may allocate resources in both the channel (or tone) domain and the time domain. For example, the radio resource management function 225 may determine that a video frame with time stamp Z should be transmitted over a selected wireless channel (or combination of channels) at time stamp RT(Z). The resources may be allocated (and/or re-allocated) at any interval. In one embodiment, such as for highly dynamic services, the reservation protocol can run frequently, while for reasonably static transmissions (such as TV) long-lasting reservations can be made.

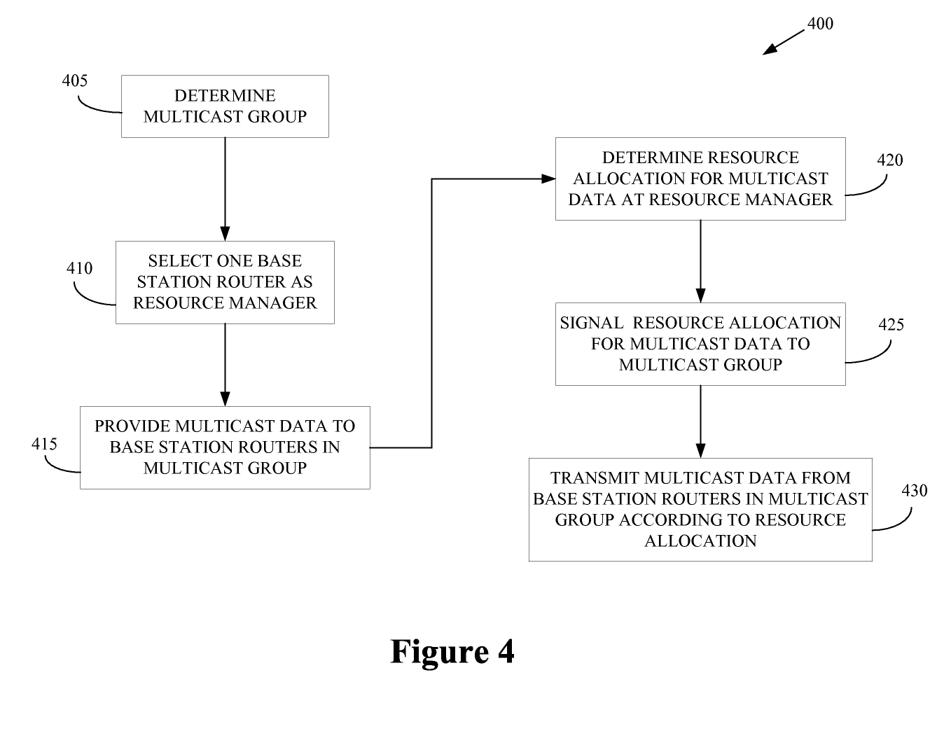

FIG. 4 conceptually illustrates one exemplary embodiment of a method 400 of allocating resources for providing broadcast services in a distributed communication system. In the illustrated embodiment, the base station routers that form the multicast group are determined (at 405). For example, base station routers may register with the multicast group so that the network may determine (at 405) that these base station routers are part of the multicast group. One of the base station routers in the multicast group may then be selected (at 410) as the resource manager. The selected based station router may then initiate radio resource manager functionality, as discussed herein. The broadcast server may also provide (at 415) multicast data to the base station routers in the multicast group. Although selection (at 410) of the resource manager and provision (at 415) of the multicast data are depicted in FIG. 4 as occurring sequentially, the present invention is not limited to the illustrated order of these events. Persons of ordinary skill in the art having benefit of the present disclosure should appreciate that selection (at 410) of the resource manager and provision (at 415) of the multicast data may occur in any order and/or concurrently.

Radio resource management functionality in the selected based station router determines (at 420) resource allocations for transmission of the broadcast of data by the base station routers in the multicast group. As discussed herein, the base station router may determine (at 420) the scheduling for transmission of the broadcast data, as well as the channels and/or tones that are used to transmit the broadcast data. Allocation (at 420) of the resources may be determined so that broadcast data (or signals indicative thereof) provided by the base station routers in the multicast group may be combined by mobile units receiving the data and/or signals. Information indicating the determined allocation of the resources may then be signaled (at 425) to the base station routers in the multicast group. The base station routers may then transmit (at 430) the broadcast data in accordance with the determined resource allocation. For example, the base station routers in the multicast group may transmit (at 430) portions of the broadcast data at the scheduled time and on the determined channels and/or tones so that mobile units receiving the signals and/or data can combine the signals and/or data.

Embodiments of the techniques for allocating resources for broadcast services in a distributed wireless communication system described herein may have a number of advantages over conventional practice. For example, the broadcast data may only be transmitted once over backhaul links between broadcast servers and the base station routers that are used to provide the broadcast data to mobile units. The radio resource management function may also be able to allocate resources in a manner that is consistent with the distributed nature of the wireless communication system. Moreover, the radio resource management function may also be able to account for properties of the base station routers, such as maximum tolerable delays and/or packet jitter. Furthermore, the resource manager may be selected in a dynamic fashion that allows the wireless communication system to account for changes in network conditions, the distribution of users, and/or the services that are being provided.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed:

1. A method, comprising:
selecting a first base station router from a plurality of base station routers, the first base station router being selected to allocate resources of the plurality of base station routers, the allocated resources being used to provide broadcast data;
providing the broadcast data to the plurality of base station routers, the broadcast data being configured for broadcast by each of the plurality of base station routers according to a resource allocation determined by the first base station router.

2. The method of claim 1, wherein selecting the first base station router comprises selecting the first base station router from the plurality of base station routers based upon at least one of a broadcast service or a broadcast region.

3. The method of claim 1, wherein selecting the first base station router comprises selecting the first base station router using at least one of a two-phase commit protocol or a three-phase commit protocol.

4. The method of claim 1, comprising negotiating identities of the plurality of base station routers with the first base station router.

5. The method of claim 1, wherein selecting the first base station router from the plurality of base station routers comprises selecting the first base station router from a plurality of base station routers that are registered with an Internet Protocol multicast group.

6. The method of claim 5, wherein providing the broadcast data comprises providing the broadcast data to the plurality of base station routers that are registered with the Internet Protocol multicast group using at least one Internet Protocol multicast function.

7. The method of claim 1, wherein providing the broadcast data comprises providing at least one portion of the broadcast data, said at least one portion including a timestamp.

8. A method, comprising:
receiving, at a first base station router, information indicating that the first base station router is selected to allocate resources of at least one second base station router, the allocated resources being used to provide broadcast data;
receiving, at the first base station router, the broadcast data, the broadcast data being configured for broadcast by the first base station router and said at least one second base station router according to a resource allocation determined by the first base station router.

9. The method of claim 8, wherein receiving the information indicating that the first base station router is selected to allocate resources of said at least one second base station router comprises negotiating identities of said at least one second base station router using at least one of a two-phase commit protocol or a three-phase commit protocol.

10. The method of claim 8, wherein receiving the broadcast data comprises receiving at least one portion of the broadcast data using at least one Internet Protocol multicast function, said at least one portion including a timestamp.

11. The method of claim 10, comprising providing, to said at least one second base station router, information indicative of a mapping between at least one transmission time for said at least one portion of the broadcast data and the timestamp.

12. The method of claim 11, wherein providing the information indicative of the mapping comprises:
receiving, from said at least one second base station router, information indicative of at least one of a delay or a jitter associated with data received at said at least one second base station router; and
determining the mapping between said at least one transmission time for said at least one portion of the broadcast data and the timestamp based upon at least one of the delay or the jitter.

13. The method of claim 8, comprising determining the resource allocation to be used for transmitting the broadcast data by the first base station and said at least one second base station.

14. The method of claim 13, wherein determining the resource allocation comprises negotiating, with said at least one second base station router, at least one channel or tone to be used for transmitting the broadcast data.

15. The method of claim 14, wherein determining the resource allocation comprises:
scheduling at least one portion of the broadcast data for transmission over at least one of the channel or the tone at a selected time; and
providing information indicative of the scheduled transmissions to said at least one second base station router.

16. The method of claim 15, comprising transmitting, from the first base station router, said at least one portion of the broadcast data at the selected time.

17. A method, comprising:
receiving, at a first base station router, information indicating that a second base station router has been selected to allocate resources of the first base station router, the allocated resources being used to provide broadcast data;
receiving, at the first base station router, the broadcast data, the broadcast data being configured for broadcast by the first base station router according to a resource allocation determined by the second base station router.

18. The method of claim 17, wherein receiving the broadcast data comprises receiving at least one portion of the broadcast data using at least one Internet Protocol multicast function, said at least one portion including a timestamp.

19. The method of claim 18, comprising receiving, at the first base station router and from the second base station router, information indicative of a mapping between at least one transmission time for said at least one portion of the broadcast data and the timestamp.

20. The method of claim 19, wherein receiving the information indicative of the mapping comprises receiving the information in response to providing, to the second base station router, information indicative of at least one of a delay or a jitter associated with data received at the first base station router.

21. The method of claim 17, comprising negotiating, with the second base station router, at least one of a channel, a tone, or a coding to be used for transmitting the broadcast data.

22. The method of claim 21, comprising receiving information indicative of a scheduled time for transmission of at least a portion of the broadcast data over said at least one channel or tone.

23. The method of claim 21, comprising transmitting, from the first base station router, said at least one portion of the broadcast data at the selected time over said at least one channel or tone.
